(19) United States
(12) Patent Application Publication
(10) Pub. No.: US 2025/0168822 A1
(43) Pub. Date: May 22, 2025

(54) METHODS OF WAVEFORM SWITCHING IN A CELLULAR NETWORK

(71) Applicants: CENTRE OF EXCELLENCE IN WIRELESS TECHNOLOGY, Tamil Nadu (IN); INDIAN INSTITUTE OF TECHNOLOGY MADRAS (IIT MADRAS), Tamil Nadu (IN)

(72) Inventors: Mohamed Ershadh SIRAJUDEEN, Tamil Nadu (IN); Dhivagar BASKARAN, Tamil Nadu (IN); Jeniston Deviraj Klutto MILLETH, Tamil Nadu (IN); Bhaskar RAMAMURTHI, Tamil Nadu (IN)

(21) Appl. No.: 18/839,113

(22) PCT Filed: Feb. 17, 2023
(86) PCT No.: PCT/IN2023/050157

§ 371 Date: Aug. 16, 2024

(30) Foreign Application Priority Data
Feb. 17, 2022 (IN) 202241008473

(51) Int. Cl. H04W 72/02; H04L 5/00; H04W 72/0453; H04W 72/1268; H04W 72/231

(52) U.S. Cl. CPC H04W 72/02; H04L 5/0044; H04W 72/0453; H04W 72/1268; H04W 72/231

(57) ABSTRACT

Methods of waveform switching in a cellular network are described. The method includes configuring, by a User Equipment, a first waveform for a Physical Uplink Shared Channel (PUSCH) transmission. A Base Station selects a second waveform for dynamically switching from the first waveform. The second waveform is used for communication in the scheduled PUSCH transmission based on waveform switching parameters. The Base Station transmits control information defined by the waveform switching parameters, to the User Equipment.

### CROSS-REFERENCE TO RELATED APPLICATIONS

This application is a U.S. National Stage Application under 35 U.S.C. § 371 of International Patent Application No. PCT/IN2023/050157, filed Feb. 17, 2023, which claims priority to Indian Patent Application No. 202241008473, filed Feb. 17, 2022, which are hereby incorporated by reference in their respective entireties.

### FIELD OF THE INVENTION

The present invention relates to cellular communication systems, and more particularly to facilitate waveform switching in a cellular network.

### BACKGROUND OF THE INVENTION

Enhancements to coverage area of a communication cell involves configuring a cell-edge user with appropriate transmission waveform to maintain connection and throughput. One of the recent methods in the New Radio (NR) specification of achieving waveform switching is by enabling transform precoding (TP) through Radio Resource Control (RRC) signaling to switch the PUSCH waveform from Cyclic Prefix Orthogonal Frequency Division Multiplexing (CP-OFDM) to Discrete Fourier Transform Spread OFDM. Since fading channel conditions are highly volatile for the cell-edge user equipment (UE), it is desired to have fast link adaptation of such UE, which includes Modulation and Coding Scheme (MCS), Precoding Matrix Index (PMI), and rank to be used for scheduling Physical Uplink Shared Channel (PUSCH). Though MCS and PMI are adaptable through signalling through DCI, a UE with TP enabled is allowed to have only single rank PUSCH transmission. Therefore, for multi-rank transmission, the UE is expected to switch to CP-OFDM by disabling TP using RRC. However, the switching speed of this control is inadequate for a UE to adapt effectively with the fading channel.

Thus, there is a need for an efficient method of waveform switching that provides the UE with appropriate choice of waveform information from the Base Station (BS) to exploit the varying radio channel conditions.

### OBJECTIVES OF THE INVENTION

An objective of the present invention is to provide a method of enabling fast waveform switching for an edge User Equipment (UE).

Another objective of the present invention is to increase efficiency of waveform switching for an edge UE.

Yet another objective of the present invention is to reduce latency of waveform switching for an edge UE.

### SUMMARY OF THE INVENTION

Before the present methods, systems, and hardware enablement are described, it is to be understood that this invention in not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

This summary is provided to introduce aspects related to a method of waveform switching in a cellular network, and the aspects are further described below in the detailed description. This summary is not intended to identify essential features of the claimed subject matter nor is it intended for use in determining or limiting the scope of the claimed subject matter.

The present invention relates to a method of waveform switching in a cellular network. The method may comprise configuring a first waveform for Physical Uplink Shared Channel (PUSCH) transmission by a Base Station (BS). The BS may select a second waveform for dynamically switching from the first waveform. The second waveform may be used for communication in a scheduled PUSCH transmission based on one or more waveform switching parameters. The BS may transmit control information defined by the one or more waveform switching parameters to the User Equipment (UE).

In one aspect, the control signal may be a Medium Access Control-Control Element (MAC-CE).

In one aspect, the one or more waveform switching parameters may include one bit information scrambled in the MAC-CE. The one bit information may be used to switch a waveform indicated in Radio Resource Control (RRC) configuration.

In one aspect, the control signal may be a Downlink Control Information (DCI). The DCI may include scheduling grant information.

In one aspect, the one or more waveform switching parameters may include one bit information scrambled in the DCI. The one bit information may be used to switch the waveform indicated in RRC configuration.

In one aspect, when the DCI with the waveform switching information is received by the UE, the UE may perform enable the waveform switching information to the PUSCH transmission scheduled by the DCI. The UE may also enable all upcoming PUSCH transmission with the waveform switching information overriding the RRC, until a new DCI without a PUSCH transmission for switching the waveform arrives. The UE may further enable the PUSCH transmission under configured grant with the waveform switching information, when the DCI is meant for activation of configured grant, until a new DCI for configured grant arrives for performing one of switching the waveform or deactivating the configured grant.

In one aspect, the UE may truncate fields in DCI format for determining payload size with respect to the waveform switching information when the UE receives the DCI with the waveform switching information as Transform Precoding (TP) enabled, and the size of fields in the DCI format with TP enabled is more than the size of fields with TP disabled.

In one aspect, the fields in the DCI format may include Precoding information, number of layers, and antenna ports. The UE may perform truncation of the field by discarding one or more of Most Significant Bits (MSBs) or Least Significant Bits (LSBs).

In one aspect, the UE may assume a pre-defined default value for the fields in the DCI format, when the UE receives the DCI with the waveform switching information as TP enabled and the size of fields with TP enabled is less than the size of fields with TP disabled.

In one aspect, when the field in the DCI format is DMRS sequence initialization, the UE may assume pre-defined default value for the field from one of ‘0’ and ‘1’. When the field is PTRS-DMRS association, the UE may assume pre-defined default value for the field from one of ‘00’, ‘01’, ‘10’, ‘11’.

In one aspect, the one or more waveform switching parameters may include a field indicating the status of the TP, added in one or more of the information elements in RRC including Control Resource Set, Search Space, Control Resource Set Zero, and Search Space Zero. The status of the TP may either be enabled or disabled.

In one aspect, the UE may perform blind decoding for the DCI. The UE may be configured to perform one of PUSCH transmission with TP enabled, when the DCI is detected with TP enabled through pre-configuration of the RRC. The UE may also perform PUSCH transmission with TP disabled, when the DCI is detected with TP disabled through pre-configuration of the RRC.

In one aspect, the one or more waveform switching parameters may include association of the TP with the Radio Network Temporary Identifier (RNTI). The UE may determine association of the TP through DCI scrambled with the RNTI to determine waveform for PUSCH transmission.

In one aspect, the UE may perform blind decoding for the DCI. The UE may further perform one of a) PUSCH transmission with TP enabled, when the DCI is identified to be attached with an RNTI having TP enabled and b) PUSCH transmission with TP disabled, when the DCI is identified to be attached with an RNTI having TP disabled.

In one aspect, the one or more waveform switching parameters may include payload size of the DCI. The payload size of the DCI may be determined separately for TP enabled and TP disabled.

In one aspect, the UE may perform blind decoding for the DCI. The UE may further perform one of a) PUSCH transmission with TP enabled, when the DCI is detected for the payload size with TP enabled and b) PUSCH transmission with TP disabled, when the DCI is detected for the payload size with TP disabled.

In one aspect, the one or more waveform switching parameters may include a scrambling identifier attached to a Physical Downlink Control Channel (PDCCH) and a corresponding Demodulation Reference Signal (DMRS). The PDCCH-DMRS may be uniquely mapped to one of TP enabled and TP disabled.

In one aspect, the UE may perform blind decoding for the DCI. The UE may further perform one of PUSCH transmission with TP enabled, when the DCI is detected using a PDCCH-DMRS-Scrambling identifier mapped to TP enabled. The UE may also perform PUSCH transmission with TP disabled, when the DCI is detected using a PDCCH-DMRS-Scrambling identifier mapped to TP disabled.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. In the drawings:

FIG. 1 illustrates a method for performing waveform switching, in accordance with an embodiment of the present invention;

FIGS. 2A and 2B illustrate an exemplary depiction of Medium Access Control-Control Element (MAC-CE) structure for performing waveform switching, in accordance with an embodiment of the present invention;

FIG. 3 illustrates a method for performing waveform switching using the MAC-CE structure, in accordance with an embodiment of the present invention;

FIG. 4 illustrates a method for performing grant waveform switching using the Downlink Control Information (DCI), in accordance with an embodiment of the present invention;

FIG. 5 illustrates a method for performing waveform switching using the DCI without scheduling PUSCH grant, in accordance with an embodiment of the present invention;

FIG. 6 illustrates a method for performing waveform switching using the DCI with activation or deactivation of configured PUSCH grant, in accordance with an embodiment of the present invention;

FIG. 7 illustrates an implicit method for determining waveform switching information through pre-configuration of Radio Resource Control (RRC), in accordance with an embodiment of the present invention;

FIG. 8 illustrates an implicit method for determining waveform switching information through pre-configuration of Radio Network Temporary Identifier (RNTI), in accordance with an embodiment of the present invention;

FIG. 9A illustrates an implicit method for payload size based waveform switching, in accordance with an embodiment of the present invention; and

FIG. 9B illustrates an implicit method for scrambling identifier based waveform switching, in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention discloses methods of waveform switching in a cellular network. The method relates to signalling methods to achieve waveform switching between Cyclic Prefix Orthogonal Frequency Division Multiplexing (CP-OFDM) and Discrete Fourier Transform Spread OFDM in a New Radio (NR) cellular network. The methods are aimed at increasing efficiency and reducing latency in switching a waveform communicated by a User Equipment (UE). In one implementation, the method may utilise explicit signalling information sent using one or more control signals to trigger a switch in the waveform. In another implementation, the method may utilise implicit signalling information to trigger a switch in the waveform.

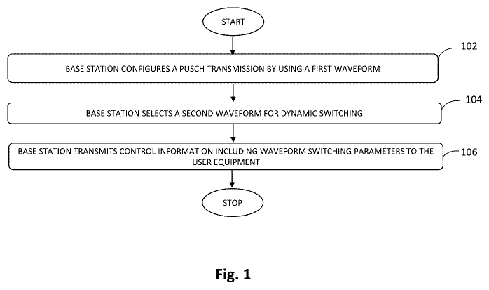

FIG. 1 illustrates a method for performing waveform switching, in accordance with an embodiment of the present invention. At step 102, a Base Station (BS) may configure a first waveform for Physical Uplink Shared Channel (PUSCH) transmission. The first waveform may be CP-OFDM waveform. At step 104, the BS may select a second waveform for dynamically switching from the first waveform. The second waveform may be used for communication in scheduled PUSCH transmission. The second waveform may be DFT-S-OFDM. The second waveform may be used for communication in a scheduled PUSCH transmission based on one or more waveform switching parameters. Upon selection of the second waveform, at step 106, the BS may transmit control information to the UE. The control information may be defined by the one or more waveform switching parameters. The UE may determine waveform switching information from the control information implicitly or explicitly. Use of the one or more waveform switching parameters for waveform switching have been defined henceforth.

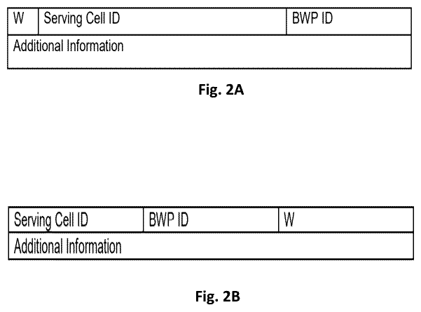

FIGS. 2A and 2B illustrate an exemplary depiction of Medium Access Control-Control Element (MAC-CE) structure for performing waveform switching, in accordance with an embodiment of the present invention. The method may utilise a bit field (alternatively referred to as a (W)) scrambled in the MAC-CE structure. The ‘W’ bit field may be one bit long. The ‘W’ bit field may indicate whether Transform Precoding (TP) indicated in Radio Resource Control (RRC) configuration, is enabled or not. In one implementation, the ‘W’ bit field may be set to 1 when the TP is enabled, and set to 0 when the TP is disabled. In an alternate aspect, the ‘W’ bit field may be set to 0 when the TP is enabled, and set to 1 when the TP is disabled.

In another implementation, the ‘W’ bit field may be used to toggle an existing waveform such as CP-OFDM configured at the UE to DFT-S-OFDM by enabling TP. In an alternate aspect, the ‘W’ bit field may be used to continue transmission in an existing waveform such as CP-OFDM configured at the UE by disabling TP.

The MAC-CE structure may also comprise other fields such as serving cell identifier, Bandwidth Parts (BWP) Identifier (Id), and additional information field. The serving cell identifier field may indicate the identity of the Serving Cell for which the MAC-CE applies. The length of the serving cell identifier field may be five bits. Additionally, the BWP Id field may indicate an Uplink BWP for which the MAC-CE applies as the codepoint value of Downlink Control Information (DCI) bandwidth part indicator field as specified in 3GPP Protocol specification TS 38.212. The length of the BWP ID field may be two bits. Further, the additional information field may contains additional information related to waveform switching including one or more of PTRS-UplinkConfig, maxRank, and DMRS-Type. FIG. 2A depicts the ‘W’ field concatenated at starting of the MAC-CE structure as a first field. FIG. 2B depicts the ‘W’ field concatenated at end of the MAC-CE structure as the last bit after the BWP Id field.

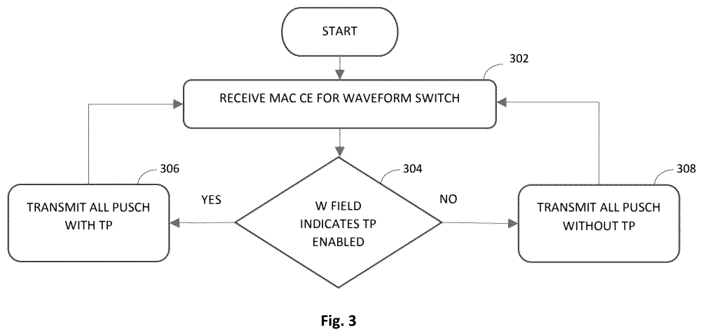

FIG. 3 illustrates a method for performing waveform switching using the MAC-CE structure, in accordance with an embodiment of the present invention. At step 302, the UE may receive a MAC-CE control signal from a Base Station (BS). The MAC-CE may contain the ‘W’ bit field. At step 304, the UE may determine whether the ‘W’ bit field is set to 1 or 0 or alternatively whether the ‘W’ bit field indicates TP is enabled or not. If the TP is enabled, the UE, at step 306, may switch waveform for communication of scheduled Physical Uplink Shared Channel (PUSCH) transmissions. The UE may transmit all scheduled PUSCH transmissions in DFT-S-OFDM waveform. After transmission, the method may loop back to step 302. If the TP is disabled, the UE, at step 308, may continue to transmit all scheduled PUSCH transmissions in CP-OFDM waveform. After transmission, the method may loop back to step 302.

In another implementation, the signalling method may utilise DCI to indicate waveform switching to the UE. In one implementation, the waveform switching information may be indicated in an uplink DCI format using an additional field. The additional field may be a one bit field. The additional field may indicate type of waveform to be used for the scheduled PUSCH grant. The additional field may be set to a value of either a ‘0’ or a ‘1’ and each value may uniquely indicate whether TP is enabled or disabled. In one implementation, the additional field may be set to 1 when the TP is enabled, and set to 0 when the TP is disabled. In an alternate aspect, the additional field may be set to 0 when the TP is enabled, and set to 1 when the TP is disabled.

In another implementation, the additional field may be used to toggle an existing waveform such as CP-OFDM configured at the UE to DFT-S-OFDM by enabling TP. In an alternate aspect, the additional field may be used to continue transmission in an existing waveform such as CP-OFDM configured at the UE by disabling TP. In yet another implementation, the additional field may also indicates a toggle information from a previously enabled waveform, such as CP-OFDM. The additional field may be set to one of the values either a ‘1’ or a ‘0’. A value of ‘1’ may indicate a toggle from the previously enabled waveform, such as CP-OFDM to a new waveform DFT-S-OFDM configured by the UE for communication. A value of ‘0’ may indicate no change to the previously enabled waveform configured for communication.

In one implementation, the uplink DCI carrying the waveform switching information in the additional field may perform one of scheduling a PUSCH grant, activating or deactivating a configured PUSCH grant, and scheduling no PUSCH grant and indicating only waveform switching information through the DCI.

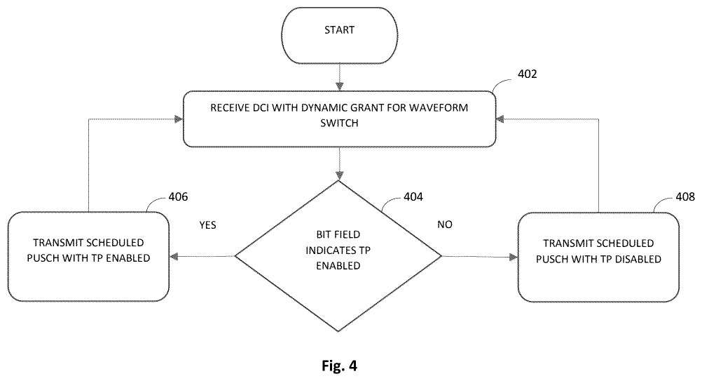

FIG. 4 illustrates a method for performing grant waveform switching using the DCI, in accordance with an embodiment of the present invention. The DCI including the additional field may be used to schedule a PUSCH grant. At step 402, the UE may receive the DCI with the waveform switching information. At step 404, the UE may determine if the additional field indicates if the TP is enabled. If the TP is enabled and if the DCI schedules a PUSCH grant, at step 406, the waveform switching information may be applicable to the scheduled PUSCH transmissions by the UE. After transmission, the method may loop back to step 402. If the TP is disabled and if the DCI schedules a PUSCH grant, at step 408, the UE may transmit the scheduled PUSCH transmissions without applying the waveform switching. After transmission, the method may loop back to step 402.

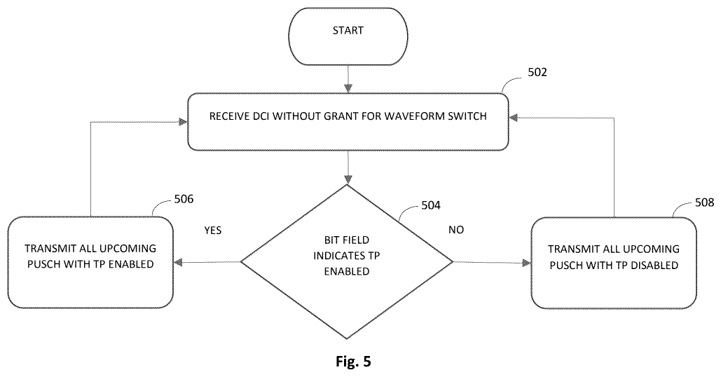

FIG. 5 illustrates a method for performing waveform switching using the DCI without scheduling PUSCH grant, in accordance with an embodiment of the present invention. The DCI including the additional field may be used to indicate only waveform switching information without scheduling a PUSCH grant. At step 502, the UE may receive the DCI with the waveform switching information without PUSCH grant. At step 504, the UE may determine if the additional field indicates if the TP is enabled. If the TP is enabled, and if the DCI does not schedule a PUSCH grant, the waveform switching information acts as an override for the RRC control signal. At step 506, the waveform switching information may be applicable to transmission of all upcoming PUSCH, until a new DCI without a PUSCH grant for switching the configured waveform arrives at the UE. After transmission, the method may loop back to step 502. If the TP is disabled, at step 508, the UE may transmit the upcoming PUSCH transmissions without applying the waveform switching. After transmission, the method may loop back to step 502.

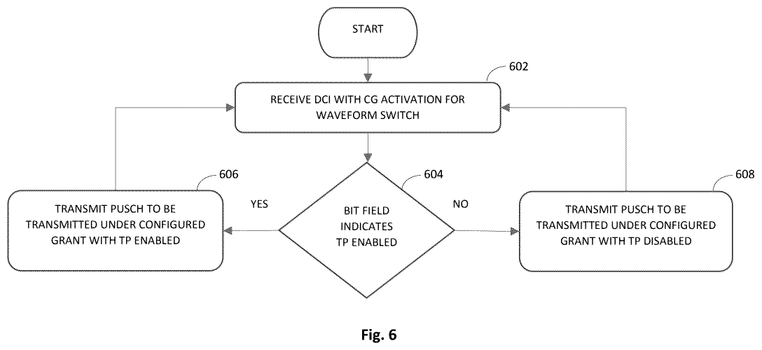

FIG. 6 illustrates a method for performing waveform switching using the DCI with activation or deactivation of configured PUSCH grant, in accordance with an embodiment of the present invention. The DCI including the additional field may be used to indicate waveform switching information and perform activation or deactivation of the configured PUSCH grant. At step 602, the UE may receive the DCI with the waveform switching information with configured PUSCH grant. At step 604, the UE may determine if the additional field indicates if the TP is enabled and if the DCI is for activation of configured PUSCH grant.

At step 606, the waveform information may be applicable to all the PUSCH to be transmitted under the configured PUSCH grant. The configured PUSCH grant may be transmitted until a new DCI for configured grant arrives, switching the waveform or deactivating the configured PUSCH grant. After transmission, the method may loop back to step 602. If the TP is disabled, at step 608, the UE may transmit the configured PUSCH grant without applying the waveform switching. After transmission, the method may loop back to step 602.

The waveform switching information included in the DCI may be utilised to interpret field information of the DCI format that may be used after waveform switching. The field information may be dependent on whether TP is enabled or not and thus the field information may have to be adjusted in the uplink DCI format.

In one scenario, when the UE may previously be configured with TP disabled and in the current DCI, the waveform switching information additional field may be set to enable TP, while calculating the payload size for detecting the DCI, the UE may calculate the sizes of the fields ‘Precoding information and number of layers’ and ‘Antenna ports’ to be with respect to TP disabled. On decoding the DCI, the fields may be truncated to the field sizes corresponding to TP enabled. Truncation may be executed by discarding one or more of Most Significant Bits (MSBs) or Least Significant Bits (LSBs).

In another scenario, when the UE may be previously configured with TP enabled and in the current DCI, the waveform switching information bit field may be set to TP disabled, while calculating the payload size for detecting the DCI, the UE may calculate the sizes of the fields ‘Precoding information and number of layers’ and ‘Antenna ports’ to be with respect to TP enabled. On decoding the DCI, the fields which are lesser in size than the case of TP disabled may be used to map indices in tables with respect to TP disabled. Mapping may be restricted to a subset of indices from the tables. A selection of the subset of indices may be based on one or more of Rank Indicator (RI), number of layers, Power Headroom Report (PHR), Channel Quality Information (CQI), Modulation and Coding Scheme (MCS), UE power class, support of Pi/2 Binary Phase-shift Keying (BPSK) and UE capability information.

In another scenario, when the UE is previously configured with TP disabled and in the current DCI, the waveform switching information bit field is set to enable TP, the field ‘PTRS-DMRS association’ may be of width zero bit. As the DCI is enabled the TP for an upcoming PUSCH, a value for ‘PTRS-DMRS association’ field may be expected by the UE. On decoding the DCI, the UE may assume a pre-defined default value for the field from one of ‘00’, ‘01’, ‘10’, ‘11’.

In another scenario, when the UE is previously configured with TP disabled, and in the current DCI, the waveform switching information bit field is to enable TP, the field ‘DMRS sequence initialization’ is of width zero bit. As the DCI enabled TP for an upcoming PUSCH, a value for ‘DMRS sequence initialization’ field may be expected by the UE, on decoding the DCI, the UE may assume a pre-defined default value for the field from one of ‘0’ and ‘1’.

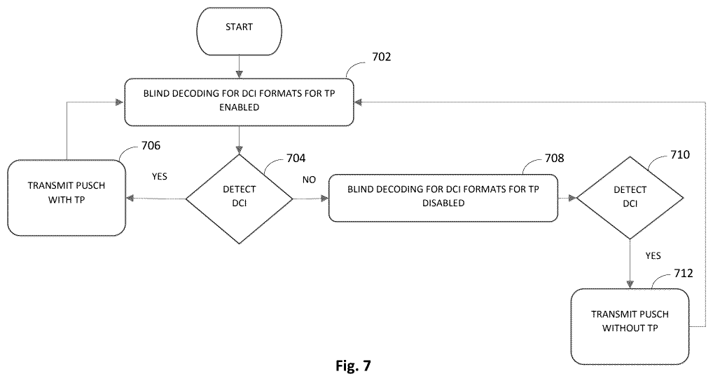

FIG. 7 illustrates an implicit method for determining waveform switching information through pre-configuration of Radio Resource Control (RRC), in accordance with an embodiment of the present invention. At step 702, the UE may perform blind decoding of a control channel for uplink DCI format over which the grant information or configured grant activation and deactivation may be received. The blind decoding may be performed for DCI format with pre-configured TP enabled. The UE may map predefined association of whether TP is enabled or disabled through RRC configuration. A field indicating TP enabled or disabled may be added in one or more of the information elements of RRC used to carry DCI. The information elements in RRC include ‘ControlResourceSet’, ‘SearchSpace’, ‘ControlResourceSetZero’, and ‘SearchSpaceZero.’ At step 704, the UE may detect the DCI. If the DCI is detected, at step 706, the UE may transmit a waveform in PUSCH while TP enabled. After transmission, the method may loop back to step 702. If the DCI is not detected, at step 708, the UE may perform blind decoding of a control channel for uplink DCI format over which the grant information or configured grant activation and deactivation may be received. The blind decoding may be performed for DCI format with pre-configured TP disabled. At step 710, the UE may detect the DCI. If the DCI is detected, at step 712, the UE may transmit a waveform in PUSCH without using TP. After transmission, the method may loop back to step 702.

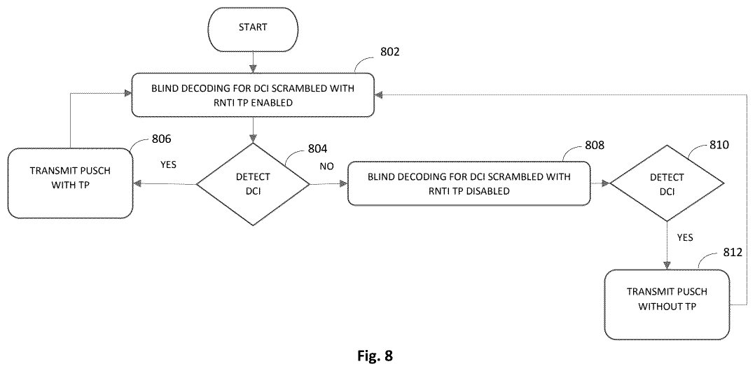

FIG. 8 illustrates an implicit method for determining waveform switching information through pre-configuration of Radio Network Temporary Identifier (RNTI), in accordance with an embodiment of the present invention. At step 802, the UE may perform blind decoding of a control channel for uplink DCI format over which the grant information or configured grant activation and deactivation may be received. The blind decoding may be performed for DCI format based on the RNTI. The UE may be configured with multiple RNTI and association of an RNTI of the multiple RNTI with status of TP may be pre-determined at the UE. The status of the TP as either enabled or disabled may be pre-determined at the UE using one of a pre-defined association or through RRC configuration.

At step 804, on receiving a DCI using a particular RNTI, the UE may map the grant corresponding to the DCI to the waveform associated with the RNTI used for detection of DCI. The UE may detect the DCI. If the DCI is detected, at step 806, the UE may transmit a waveform in PUSCH while using TP. After transmission, the method may loop back to step 802. If the DCI is not detected, at step 808, the UE may perform blind decoding of a control channel for uplink DCI format over which the grant information or configured grant activation and deactivation may be received. The blind decoding may be performed for DCI format with pre-configured TP disabled. At step 810, the UE may detect the DCI. If the DCI is detected, at step 812, the UE may transmit a waveform in PUSCH without using TP. After transmission, the method may loop back to step 802.

In one example, uplink grants scheduled by DCIs scrambled with a Modulation and Coding Scheme Cell RNTI (MCS-C-RNTI) which is used to select low spectral efficiency table may be associated with TP enabled, whereas DCIs scrambled with Cell RNTI (C-RNTI) may be associated with TP disabled. Therefore, when the UE detects a DCI using MCS-C-RNTI, the corresponding PUSCH grant may be transmitted using TP and when the UE detects a DCI using C-RNTI, the corresponding PUSCH grant may be transmitted without using TP.

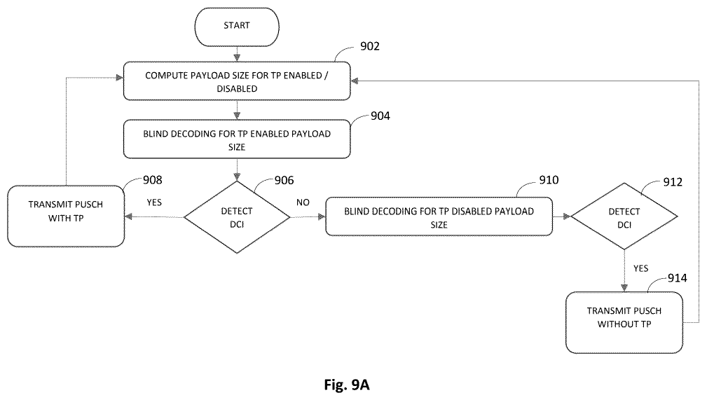

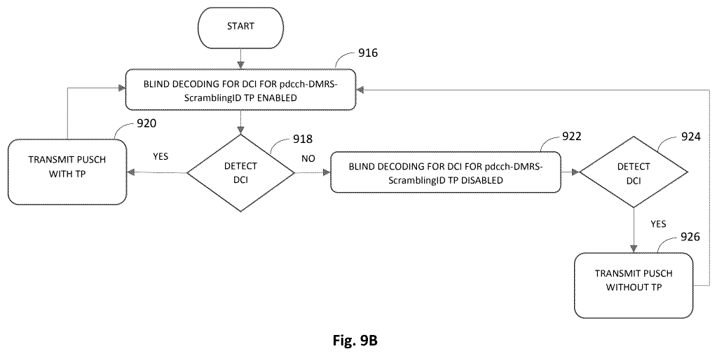

FIG. 9A illustrates an implicit method for payload size based waveform switching, in accordance with an embodiment of the present invention. At step 902, the UE may compute more than one payload size for TP enabled and TP disabled. At step 904, the UE may perform blind decoding for DCI corresponding to a payload size computed assuming TP enabled. At step 906, the UE may detect a DCI corresponding to the payload size with TP enabled. If the DCI is detected, at step 908, the UE may transmit corresponding PUSCH with TP enabled. After transmission, the method may loop back to step 902. If the DCI is not detected, at step 910, the UE may perform blind decoding for DCI corresponding to a payload size computed assuming TP disabled. At step 912, the UE may detect the DCI. If the DCI is detected, at step 914, the UE may transmit a waveform in PUSCH without using TP. After transmission, the method may loop back to step 902.

FIG. 9B illustrates an implicit method for scrambling identifier based waveform switching, in accordance with an embodiment of the present invention. At step 916, the UE may perform blind decoding for DCI using more than one PDCCH-DMRS-ScramblingID each mapping uniquely to TP enabled. At step 918, the UE may detect a DCI corresponding to the PDCCH-DMRS-ScramblingID mapped to the TP enabled. If the DCI is detected, at step 920, the UE may transmit corresponding PUSCH with TP enabled. After transmission, the method may loop back to step 916. If the DCI is not detected, at step 918, the UE may perform blind decoding for DCI corresponding to more than one PDCCH-DMRS-ScramblingID assuming each PDCCH-DMRS-ScramblingID is mapped uniquely to TP disabled. At step 920, the UE may detect the DCI. If the DCI is detected, at step 922, the UE may transmit a waveform in PUSCH without using TP. After transmission, the method may loop back to step 916.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method of waveform switching in a cellular network, the method comprising:
configuring, by a Base Station (BS), a first waveform for Physical Uplink Shared Channel (PUSCH) transmission;
selecting, by the BS, a second waveform for dynamically switching from the first waveform, wherein the second waveform is used for communication in a scheduled PUSCH transmission based on one or more waveform switching parameters; and
transmitting, by the BS, control information defined by the one or more waveform switching parameters, to a User Equipment (UE).

2. The method as claimed in claim 1, wherein the control signal is a Medium Access Control-Control Element (MAC-CE).

3. The method as claimed in claim 2, wherein the one or more waveform switching parameters include one bit information scrambled in the MAC-CE, and wherein the one bit information is used to switch a waveform indicated in Radio Resource Control (RRC) configuration.

4. The method as claimed in claim 1, wherein the control signal is a Downlink Control Information (DCI), and the DCI includes scheduling grant information.

5. The method as claimed in claim 4, wherein the one or more waveform switching parameters include one bit information scrambled in the DCI, and wherein the one bit information is used to switch the waveform indicated in RRC configuration.

6. The method as claimed in claim 4, wherein when the DCI with the waveform switching information is received by the UE, the UE performs one of:
enabling the waveform switching information to the PUSCH transmission scheduled by the DCI;
enabling all upcoming PUSCH transmission with the waveform switching information overriding the RRC, until a new DCI without a PUSCH transmission for switching the waveform arrives; and
enabling the PUSCH transmission under configured grant with the waveform switching information, when the DCI is meant for activation of configured grant, until a new DCI for configured grant arrives for performing one of switching the waveform or deactivating the configured grant.

7. The method as claimed in claim 4, further comprising truncating fields in DCI format by the UE, for determining payload size with respect to the waveform switching information when the UE receives the DCI with the waveform switching information as Transform Precoding (TP) enabled, and the size of fields in the DCI format with TP enabled is more than the size of fields with TP disabled.

8. The method as claimed in claim 7, wherein the fields in the DCI format include Precoding information, number of layers, and antenna ports, and wherein the UE performs truncation of the field by discarding one or more of Most Significant Bits (MSBs) or Least Significant Bits (LSBs).

9. The method as claimed in claim 4, wherein when the UE receives the DCI with the waveform switching information as TP enabled and the size of fields with TP enabled is less than the size of fields with TP disabled, the UE assumes a pre-defined default value for the field.

10. The method as claimed in claim 9, wherein when the field in the DCI format is DMRS sequence initialization, the UE assumes pre-defined default value for the field from one of ‘0’ and ‘1’, and when the field is PTRS-DMRS association, the UE assumes pre-defined default value for the field from one of ‘00’, ‘01’, ‘10’, ‘11’.

11. The method as claimed in claim 1, wherein the one or more waveform switching parameters include a field indicating the status of the TP added in one or more of the information elements in RRC including Control Resource Set, Search Space, Control Resource Set Zero, and Search Space Zero, and wherein the status of the TP is either enabled or disabled.

12. The method as claimed in claim 11, wherein the UE performs blind decoding for the DCI and performs one of:
PUSCH transmission with TP enabled, when the DCI is detected with TP enabled through pre-configuration of the RRC; and
PUSCH transmission with TP disabled, when the DCI is detected with TP disabled through pre-configuration of the RRC.

13. The method as claimed in claim 1, wherein the one or more waveform switching parameters include association of the TP with the Radio Network Temporary Identifier (RNTI), and wherein the UE determines association of the TP through DCI scrambled with the RNTI to determine waveform for PUSCH transmission.

14. The method as claimed in claim 13, wherein the UE performs blind decoding for the DCI and performs one of:
PUSCH transmission with TP enabled, when the DCI is identified to be attached with an RNTI having TP enabled; and
PUSCH transmission with TP disabled, when the DCI is identified to be attached with an RNTI having TP disabled.

15. The method as claimed in claim 1, wherein the one or more waveform switching parameters include payload size of the DCI, and wherein the payload size of the DCI is determined separately for TP enabled and TP disabled.

16. The method as claimed in claim 15, further comprising performing, by the UE, blind decoding for the DCI, and the UE is configured to further perform one of:
PUSCH transmission with TP enabled, when the DCI is detected for the payload size with TP enabled; and
PUSCH transmission with TP disabled, when the DCI is detected for the payload size with TP disabled.

17. The method as claimed in claim 1, wherein the one or more waveform switching parameters include a scrambling identifier attached to a Physical Downlink Control Channel (PDCCH) and a corresponding Demodulation Reference Signal (DMRS), and wherein the PDCCH-DMRS is uniquely mapped to one of TP enabled and TP disabled.

18. The method as claimed in claim 17, wherein the UE performs blind decoding for the DCI and performs one of:
PUSCH transmission with TP enabled, when the DCI is detected using a PDCCH-DMRS-Scrambling identifier mapped to TP enabled; and
PUSCH transmission with TP disabled, when the DCI is detected using a PDCCH-DMRS-Scrambling identifier mapped to TP disabled.
